(19) United States
(12) Patent Application Publication
(10) Pub. No.: US 2024/0163978 A1
(43) Pub. Date: May 16, 2024

(54) ELECTRIC HEATING MATERIAL PROCESSING DEVICE, SERIES ELECTRIC HEATING MATERIAL PROCESSING DEVICE, AND PARALLEL ELECTRIC HEATING MATERIAL PROCESSING DEVICE

(71) Applicant: YUH SHAN ENVIRONMENTAL ENGINEERING CO., LTD., Kaohsiung City (TW)

(72) Inventors: Huang-Long LIN, Kaohsiung City (TW); Yuan-Hung LIU, Kaohsiung City (TW); Yu-Chi CHANG, Kaohsiung City (TW)

(21) Appl. No.: 18/173,810

(22) Filed: Feb. 24, 2023

(30) Foreign Application Priority Data
Nov. 10, 2022 (TW) 111212332

(51) Int. Cl. H05B 3/78; H05B 3/16

(52) U.S. Cl. CPC H05B 3/78; H05B 3/16

(57) ABSTRACT

An electric heating material processing device includes a material transporting module, a material feeding controller, a material discharging controller, a gas vent, and an electric heating thermal desorption device. The material transporting module has a material inlet and a material outlet. The material feeding controller is connected to the material inlet, and is configured to control a feeding quantity and a feeding speed of the materials. The material discharging controller is connected to the material outlet, and is configured to control a discharging quantity and a discharging speed of the materials. The gas vent is disposed on an end of the material transporting module. The electric heating thermal desorption device is disposed on an outer surface of the material transporting module, and is configured to perform a thermal desorption process on the materials. The electric heating thermal desorption device includes an electric heating acceptor and plural electric heaters.

### RELATED APPLICATIONS

This application claims priority to Taiwan Application Serial Number 111212332, filed Nov. 10, 2022, which is herein incorporated by reference in its entirety.

### BACKGROUND

### Field of Invention

The present disclosure relates to a material processing device. More particularly, the present disclosure relates to an electric heating material processing device that uses an electric heating thermal desorption device to perform a thermal desorption treatment, and a series electric heating material processing device and a parallel electric heating material processing device, which are composed of plural electric heating material processing devices.

### Description of Related Art

In the situation that materials have been seriously contaminated, people usually heat the materials by direct or indirect ways, so as to vaporize or separate water, oil, and other organic contaminants from the materials. This process is called a thermal desorption. The conventional thermal desorption devices are furnaces, and heat sources are fuels (for example, diesel, natural gas, and gas). The conventional thermal desorption device detaches the contaminants inside the materials through conduction and convection by using high temperature combustion.

However, the conventional thermal desorption device has several drawbacks. First of all, in the thermal desorption device using traditional fuels as heat sources, a fuel system is usually a regulated apparatus, such that the construction time is long, the project is complicated, and it is difficult to set up. In addition, since refractory materials and fireproof materials must be equipped inside the thermal desorption devices, the conventional thermal desorption device is cumbersome and occupies a considerable space, and is hard to transport. Furthermore, under the rapid change of technology, the technology of the traditional thermal desorption device has declined, such that shortages of human resources have gradually emerged in device construction and maintenance.

Therefore, there is a need for a new thermal desorption device, which can maintain or even increase a production capacity of the thermal desorption device on a premise of improving many problems such as an inconvenience construction, manpower maintenance, and difficult maintenance of the conventional thermal desorption device.

### SUMMARY

Accordingly, an objective of the present disclosure is to provide an electric heating material processing device including plural electric heaters and an electric heating acceptor. After receiving energy of the electric heaters, the electric heating acceptor converts electric energy to heat energy, and materials absorb the heat energy of the electric heating acceptor to perform a thermal desorption process. After heating, internal contaminants are physically separated from the materials. Since the electric heating material processing device with this heating form does not need to be equipped with a conventional combustion furnace, the construction of the electric heating material processing device is much easier than that of the conventional thermal desorption device, and the weight of the electric heating material processing device is relatively lighter as well.

According to the aforementioned objectives of the present disclosure, an electric heating material processing device is provided. The electric heating material processing device includes a material transporting module, a material feeding controller, a material discharging controller, a gas vent, and an electric heating thermal desorption device. The material transporting module is configured to transport plural materials, in which the material transporting module has a material inlet and a material outlet. The material feeding controller is connected to the material inlet, in which the material feeding controller is configured to control a feeding quantity of the materials and a feeding speed of the materials when the materials enter the material transporting module. The material discharging controller is connected to the material outlet, in which the material discharging controller is configured to control a discharging quantity of the materials and a discharging speed of the materials when the materials leave the material transporting module. The gas vent is disposed on an end of the material transporting module, in which the gas vent is configured to discharge a volatile gas. The electric heating thermal desorption device is disposed on an outer surface of the material transporting module, in which the electric heating thermal desorption device is configured to perform a thermal desorption process on the materials, and the electric heating thermal desorption device includes an electric heating acceptor and plural electric heaters. The electric heating acceptor is disposed on the outer surface of the material transporting module. The electric heaters contact a portion of the electric heating acceptor.

According to some embodiments of the present disclosure, the aforementioned electric heating material processing device further includes a feeding material thermometer and a discharging material thermometer. The feeding material thermometer is disposed adjacent to the material feeding controller, in which the feeding material thermometer is configured to measure a feeding temperature of the material around the material feeding controller. The discharging material thermometer is disposed adjacent to the material discharging controller, in which the discharging material thermometer is configured to measure a discharging temperature of the material around the material discharging controller.

According to some embodiments of the present disclosure, the aforementioned electric heating material processing device further includes a central control system. The central control system is signally connected to the material transporting module, the material feeding controller, the material discharging controller, the electric heaters, the feeding material thermometer, and the discharging material thermometer, in which the central control system is configured to control plural material process parameters of the electric heating material processing device, and the material process parameters includes a feeding speed parameter, a feeding temperature parameter, a transporting speed parameter, a heating energy parameter, a heating time parameter, a discharging speed parameter, and a discharging temperature parameter.

According to some embodiments of the present disclosure, the aforementioned material transporting module has a first opening and a second opening respectively disposed at two ends of the material transporting module opposite to each other, and the material transporting module includes a material transporting device, two covers, and a motor. The material transporting device is configured to move the materials from the first opening to the second opening. The two covers are respectively covering the first opening and the second opening, in which the two covers are configured to seal the first opening and the second opening. The motor is engaged with the material transporting device in which the motor is configured to drive the material transporting device.

According to some embodiments of the present disclosure, the aforementioned electric heaters are electric resistance heaters.

According to the aforementioned objectives of the present disclosure, a series electric heating material processing device is provided. The series electric heating material processing device includes a material tank and plural electric heating material processing devices as shown above. The material tank is configured to store plural materials. The material feeding controller of the first one of the electric heating material processing device is connected to the material tank, and the material feeding controller of each of the remaining electric heating material processing devices is connected to the material discharging controller of another one of the remaining electric heating material processing devices.

According to the aforementioned objectives of the present disclosure, a parallel electric heating material processing device is provided. The parallel electric heating material processing device includes a material tank, a material distributor, plural distributing pipes, and plural electric heating material processing devices as shown above. The material tank is configured to store plural materials. The material distributor is connected to the material tank, and is configured to extract the materials from the material tank. The distributing pipes are connected to the material distributor, in which the distributing pipes are configured to distribute the materials. The material feeding controllers of the electric heating material processing devices are correspondingly connected to the distributing pipes.

According to the aforementioned objectives of the present disclosure, an electric heating material processing device is provided. The electric heating material processing device includes a material transporting module, a material feeding controller, a material discharging controller, a gas vent, and an electric heating thermal desorption device. The material transporting module is configured to transport plural materials, in which the material transporting module has a material inlet and a material outlet. The material feeding controller is connected to the material inlet, in which the material feeding controller is configured to control a feeding quantity of the materials and a feeding speed of the materials when the materials enter the material transporting module. The material discharging controller is connected to the material outlet, in which the material discharging controller is configured to control a discharging quantity of the materials and a discharging speed of the materials when the materials leave the material transporting module. The gas vent is disposed on an end of the material transporting module, in which the gas vent is configured to discharge a volatile gas. The electric heating thermal desorption device is disposed on an outer surface of the material transporting module, in which the electric heating thermal desorption device is configured to perform a thermal desorption process on the materials, and the electric heating thermal desorption device includes an electric heating acceptor and plural electric heaters. The electric heating acceptor is disposed on the outer surface of the material transporting module. The electric heaters are adjacent to and do not contact the electric heating acceptor.

According to some embodiments of the present disclosure, the aforementioned electric heaters are electromagnetic induction heaters.

According to some embodiments of the present disclosure, the aforementioned series electric heating material processing device further includes plural central control systems. The central control systems are signally connected to the material transporting modules, the material feeding controllers, the material discharging controllers, and the electric heating thermal desorption devices correspondingly, in which the central control systems are configured to control plural material process parameters of the electric heating material processing devices.

According to the embodiments of the present disclosure, the present disclosure mainly uses a design of the electric heating thermal desorption device to convert electrical energy to thermal energy to perform a thermal desorption process on the materials in the material transporting module. Since the electric heating thermal desorption device is substituted for the traditional combustion furnace, the construction space of the electric heating thermal desorption device is greatly saved, the weight is reduced, and the convenience of transportation is increased. Additionally, the electric heating material processing device of the present disclosure further includes a central control system. The central control system is signally connected to the material transporting module, the material feeding controller, the material discharging controller, the electric heating thermal desorption device, the feeding material thermometer, and the discharging material thermometer, and hence it can immediately monitor the process parameters of each element, and can receive feedback signals to adjust the error elements when the process parameters are abnormal, so as to automatically eliminate abnormality in real time. The central control system not only achieves precise control of the entire electric heating thermal desorption device, but also significantly saves the human resources for maintaining the device.

Furthermore, plural electric heating material processing devices of the present disclosure can be combined to form a series electric heating material processing devices and a parallel electric heating material processing devices. Since the series electric heating material processing device is formed by connecting many electric heating material processing devices in series, the materials go through the thermal desorption process in the series electric heating material processing device than that in the single electric heating material processing devices, and consequently have a higher temperature after leaving the series electric heating material processing device. In other words, the materials leaving the series electric heating material processing device have a better result of the thermal desorption treatment. The parallel electric heating material processing device uses the material distributor to evenly allocate the materials to every electric heating material processing device, and hence the thermal desorption process can be implemented more rapidly and efficiently comparing to those of the single electric heating material processing device, and further greatly increase the production capacity.

### BRIEF DESCRIPTION OF THE DRAWINGS

For a better understanding the aforementioned and other objectives, features, traits, and embodiments of the present disclosure, detailed descriptions of the accompanying figures are presented as follow:

FIG. 1 illustrates a schematic diagram of an electric heating material processing device in accordance with some embodiments of the present disclosure;

FIG. 2A illustrates a schematic diagram of an electric heating thermal desorption device in accordance with some embodiments of the present disclosure;

FIG. 2B illustrates a schematic diagram of an electric heating thermal desorption device in accordance with another embodiments of the present disclosure;

FIG. 3 illustrates a schematic diagram of a series electric heating material processing device in accordance with some embodiments of the present disclosure; and

FIG. 4 illustrates a schematic diagram of a parallel electric heating material processing device in accordance with some embodiments of the present disclosure.

### DETAILED DESCRIPTION

The embodiments of the present disclosure are described explicitly as follow. However, it is understood that the embodiments provide many applicable concepts that can be applied in various specific contents. These are merely examples and are not intended to limit the present disclosure.

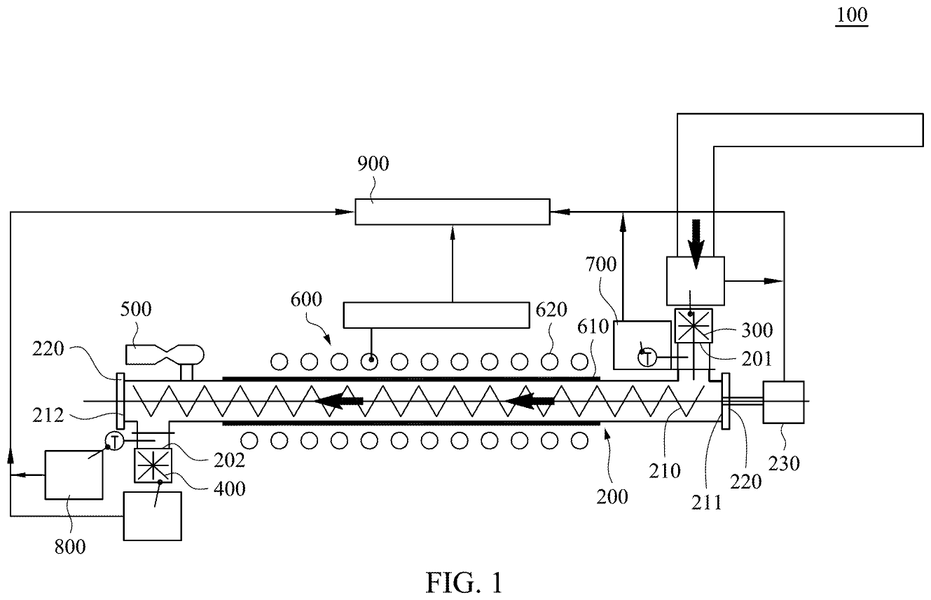

Referring to FIG. 1, FIG. 1 illustrates a schematic diagram of an electric heating material processing device in accordance with some embodiments of the present disclosure. In some embodiments, an electric heating material processing device 100 includes a material transporting module 200, a material feeding controller 300, a material discharging controller 400, a gas vent 500, and an electric heating thermal desorption device 600. The electric heating material processing device 100 is configured to perform a thermal desorption process, so as to remove the contaminants from the materials. In some embodiments, the contaminants includes, but are not limited to, organochlorides, benzene series, kerosene, mercury, pesticide, polychlorinated biphenyl, and oil pollution.

The material transporting module 200 is configured to transport plural materials and may be in a shape of pipe. The material transporting module 200 has a material inlet 201 and a material outlet 202. As shown in FIG. 1, in some embodiments, the material transporting module 200 has a first opening 211 and a second opening 212 respectively disposed at two opposite ends of the material transporting module 200, and the material transporting module 200 includes a material transporting device 210, two covers 220, and a motor 230. Concretely speaking, when performing a thermal desorption process, the materials to be processed enter from a front end, the so-called material inlet 201, into the material transporting module 200 at first, and is subsequently moved to a back end, the so-called material outlet 202, through a movement of the material transporting module 200 under a closed environment.

The material transporting device 210 is configured to move the materials from the first opening 211 to the second opening 212. It is noted that the drawings of the present disclosure are merely used to explain, and are not used to limit the present disclosure. In some embodiments, a shape of the material transporting device 210 is not limited to a Z shape as shown in FIG. 1 and can be any suitable shape, as long as the materials can be normally transported therein without stagnation.

Referring to FIG. 1, in some embodiments, the two covers 220 cover the first opening 211 and the second opening 212. The two covers 220 are configured to seal the first opening 211 and the second opening 212, so as to prevent the materials from leakage while transporting.

The motor 230 is configured to drive the material transporting device 210 to operate, so as to further drive the materials forward, which is the source of power for transporting. The motor 230 may be any kind of motor which can drive the material transporting device 210. In some embodiments, the motor 230 may be an inverter motor, such that an operator can immediately and frequently adjust a speed of transporting the materials.

As shown in FIG. 1, the material feeding controller 300 is connected to the material inlet 201. In some embodiments, the material feeding controller 300 includes a motor, such that a feeding quantity and a feeding speed of the materials entering the material inlet 201 of the material transporting module 200 can be adjusted.

The material discharging controller 400 is connected to the material outlet 202. In some embodiments, the material discharging controller 400 includes a motor, such that a discharging quantity and a discharging speed of the materials leaving the material outlet 202 of the material transporting module 200 can be adjusted.

The gas vent 500 is disposed at the end of the material transporting module 200. Concretely speaking, after the heating of the electric heating thermal desorption device 600, water, oil pollution, and other volatile substances become vapors due to high temperature. These vapors can be discharged from the material transporting module 200 through the gas vent 500. In some embodiments, the gas vent 500 may be a pulsed venture tube which uses the venturi effect to swiftly discharge the volatile gas from the material transporting module 200, thereby purifying the material transporting module 200.

The electric heating thermal desorption device 600 is disposed on an outer surface of the material transporting module 200, and is configured to heat the materials in the material transporting module 200, so as to perform the thermal desorption process on the materials. The electric heating thermal desorption device 600 includes an electric heating acceptor 610 and plural electric heaters 620. The electric heating acceptor 610 is disposed on the outer surface of the material transporting module 200. The electric heating acceptor 610 can receive energy from the electric heaters 620, and convert the received electrical energy into thermal energy, so as to perform the thermal desorption process on the materials in the material transporting module 200. After the materials are heated, contaminants in the materials are physically separated from the materials. Therefore, the heating of the electric heating thermal desorption device 600 can purify the materials in the material transporting module 200.

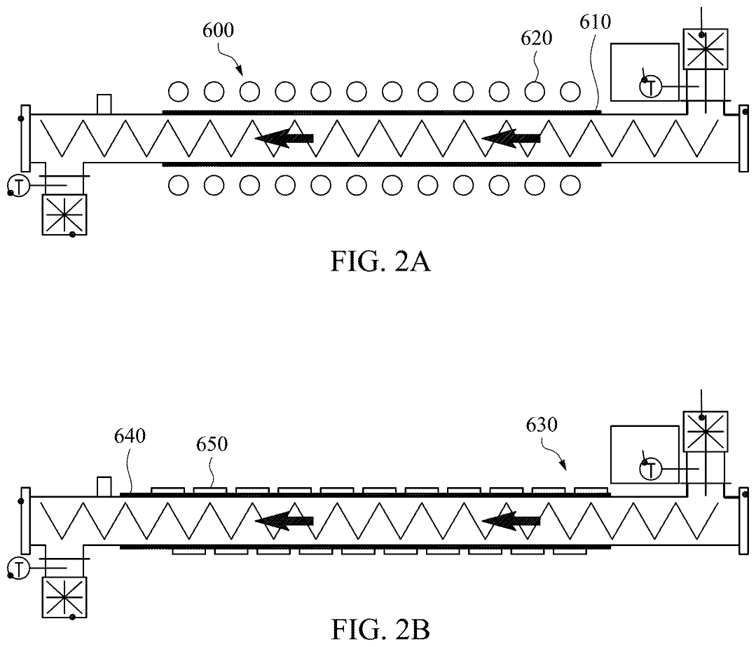

Referring to FIG. 2A and FIG. 2B, FIG. 2A illustrates a schematic diagram of an electric heating thermal desorption device in accordance with some embodiments of the present disclosure, and FIG. 2B illustrates a schematic diagram of an electric heating thermal desorption device in accordance with another embodiments of the present disclosure. In some embodiments, the electric heating material processing device 100 of the present disclosure can use a electric heating thermal desorption device 600 or an electric heating thermal desorption device 630.

As shown in FIG. 2A, when the electric heating material processing device 100 uses the electric heating thermal desorption device 600, the electric heating thermal desorption device 600 heats the electric heating acceptor 610 made of a conductive material through electromagnetic induction. Since the conductive electric heating acceptor 610 of the conductive material generates eddy current in the metal acceptor through the electromagnetic induction and further generates energy, the effect of heating can be achieved when the electric heaters 620 are not in contact with the conductive electric heating acceptor 610.

As shown in FIG. 2B, when the electric heating material processing device 100 uses the electric heating thermal desorption device 630, electric heaters 650 are resistance heaters. The electric heaters 650 contact an electric heating acceptor 640, and generate heat through resistance to heat the electric heating acceptor 640. The operator can adjust current to correspondingly adjust the heating energy of the electric heaters 650, and transfer the heat energy to the electric heating acceptor 640, so as to obtain a desired heating effect.

Referring to FIG. 1, in some embodiments, the electric heating material processing device 100 further includes a feeding material thermometer 700. The feeding material thermometer 700 is disposed adjacent to the material feeding controller 300, and is configured to measure a feeding material temperature at a periphery of the material feeding controller 300. Concretely speaking, the feeding material thermometer 700 detects the temperature when the materials enter the material inlet 201. The user can derive the acquired heat by performing the thermal desorption process based on the input material temperature. In some embodiments, the feeding material thermometer 700 can be, but not limited to, a digital thermometer. The feeding material thermometer 700 can be any kind of thermometer which is able to detect the input material temperature precisely.

In some embodiments, the electric heating material processing device 100 further includes a discharging material thermometer 800. The discharging material thermometer 800 is disposed adjacent to the material discharging controller 400, and is configured to detect a discharging material temperature at a periphery of the discharging material thermometer 800. Concretely saying, the discharging material thermometer 800 detects a temperature of the material while the material is leaving the material outlet 202. The user can determine a result of the thermal desorption process based on the discharging material temperature, and determining whether it is necessary to adjust process parameters of the thermal desorption process or not. The discharging material thermometer 800 can be, but not limited to be, a digital thermometer. The discharging material thermometer 800 can be any kind of thermometer which is able to detect the input material temperature precisely.

Referring to FIG. 1, in some embodiments, the electric heating material processing device 100 further includes a central control system 900. The central control system 900 is signally connected to the material transporting module 200, the material feeding controller 300, the material discharging controller 400, the electric heaters 620, the feeding material thermometer 700, and the discharging material thermometer 800, and is configured to control plural material processing parameters of the electric heating material processing device 100. In some examples, the material processing parameters includes, but not limited to, a feeding speed parameter, a feeding temperature parameter, a transporting speed parameter, a heating energy parameter, a heating time parameter, a discharging speed parameter, and a discharging temperature parameter. Concretely speaking, when the electric heating material processing device 100 is operating, the central control system 900 can collect the material processing parameters of each element connected to the central control system 900. The user can pre-set a standard value range of each material process parameters, such that the corresponding element is adjusted automatically when the material process parameter fed back by each element falls outside the standard value range of the material process parameters, so as to achieve a precise control.

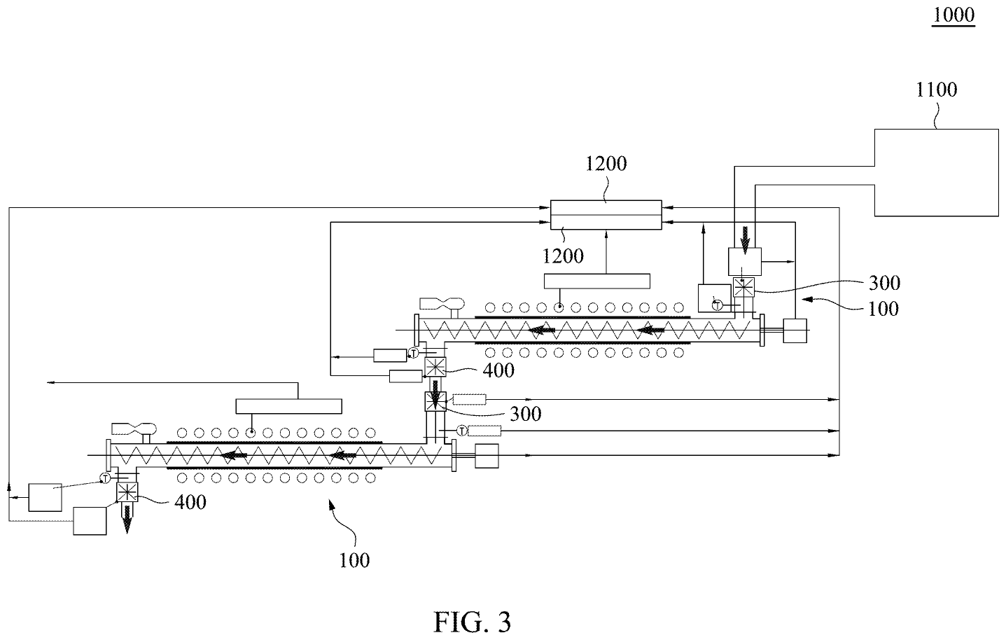

Referring to FIG. 3, FIG. 3 illustrates a schematic diagram of a series electric heating material processing device in accordance with some embodiments of the present disclosure. A series electric heating material processing device 1000 includes a material tank 1100 and plural electric heating material processing devices 100 as shown in FIG. 1.

The material tank 1100 is configured to store plural materials. The material tank 1100 can be any kind of tank which is capable of storing the materials.

In the series electric heating material processing device 1000, the electric heating material processing devices 100 are connected to each other in series. Concretely saying, the material feeding controller 300 of the first one of the electric heating material processing devices 100 is connected to the material tank 1100, and the material feeding controller 300 of each of the other ones of the electric heating material processing devices 100 is connected to the material discharging controller 400 of another electric heating material processing device 100. It is noted that FIG. 3 is only for illustration, not for limitation. In some embodiments, the series electric heating material processing device 1000 can be formed by connecting more than three electric heating material processing devices 100 in series. Since the series electric heating material processing device 1000 is formed by connecting many electric heating material processing devices 100 in series, the materials go through the longer thermal desorption process in the series electric heating material processing device 1000 than that in the single electric heating material processing devices 100, and consequently the materials have a higher temperature after leaving the series electric heating material processing device 1000. In other words, the materials have a better result of the thermal desorption process.

In some embodiments, the series electric heating material processing device 1000 further includes plural central controlling systems 1200. The central controlling systems 1200 are signally connected to each corresponding elements of the electric heating material processing devices 100, and are configured to control plural material process parameters of the electric heating material processing devices 100. Therefore, the user can pre-set a standard value range of each material process parameter, such that the corresponding element is adjusted automatically when the material process parameter fed back by each element falls outside the standard value range of the material process parameters, so as to achieve a precise control.

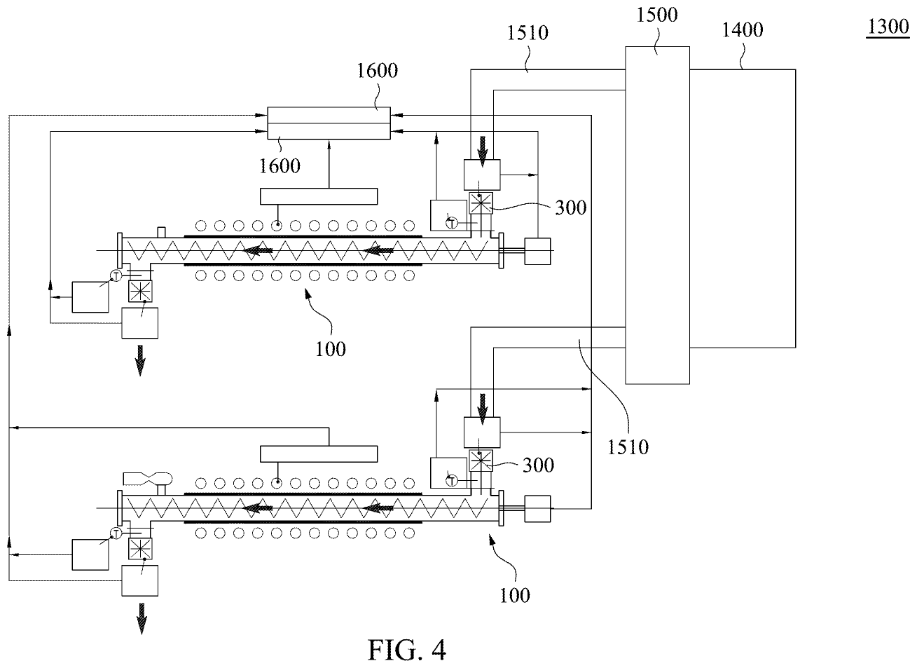

Referring to FIG. 4, FIG. 4 illustrates a schematic diagram of a parallel electric heating material processing device in accordance with some embodiments of the present disclosure. In some embodiments, a parallel electric heating material processing device 1300 includes a material tank 1400, a material distributor 1500, plural distributing pipes 1510, and plural electric heating material processing devices 100 as shown in FIG. 1.

The material tank 1400 is configured to store the materials. The material distributor 1500 is connected to the material tank 1400, and is configured to extract the materials from the material tank 1400. The distributing pipes 1510 are connected to the material distributor 1500, and are configured to distribute the materials into the electric heating material processing devices 100.

In the parallel electric heating material processing device 1300, the electric heating material processing devices 100 are connected to each other in parallel. Concretely saying, the material feeding controller 300 of each electric heating material processing device 100 is correspondingly connected to the distributing pipes 1510. Since the parallel electric heating material processing device 1300 has one or more electric heating material processing devices 100, the materials evenly distributed from the material tank 1400 are distributed to the parallel electric heating material processing devices 100 through the material distributor 1500. Moreover, through the parallel design, the production capacity can be increased in multiples, thereby effectively increasing the efficiency. It is noted that the figures of the present disclosure are only for illustration, not for limitation, therefore, even though the parallel electric heating material processing device 1300 in FIG. 4 only connects two electric heating material processing devices 100 in parallel, the parallel electric heating material processing device 1300 can actually connect more than two of electric heating material processing devices 100 in parallel.

As shown in FIG. 4, in some embodiments, the parallel electric heating material processing device 1300 further includes plural central control systems 1600. The central control systems 1600 are signally connected to each elements of the electric heating material processing devices 100 correspondingly, and are configured to control plural material process parameters of the electric heating material processing devices 100. Concretely saying, each electric heating material processing device 100 has the corresponding central control system 1600. Hence, when each of the electric heating material processing devices 100 is operating, the corresponding central control system 1600 can collect the material process parameters of each element connected to the central control system 1600. The user can pre-set a standard value range of each material process parameters, such that the corresponding element is adjusted automatically by the central control system 1600 when the material process parameter fed back by each element falls outside the standard value range of the material process parameters, so as to achieve a precise control.

According to the embodiments of the present disclosure, the present disclosure mainly uses a design of the electric heating thermal desorption device to convert electrical energy to thermal energy to perform a thermal desorption process on the materials in the material transporting module. Since the electric heating thermal desorption device is substituted for the traditional combustion furnace, the construction space of the electric heating thermal desorption device is greatly saved, the weight is reduced, and the convenience of transportation is increased. Additionally, the electric heating material processing device of the present disclosure further includes a central control system. The central control system is signally connected to the material transporting module, the material feeding controller, the material discharging controller, the electric heating thermal desorption device, the feeding material thermometer, and the discharging material thermometer, and hence it can immediately monitor the process parameters of each element, and can receive feedback signals to adjust the error elements when the process parameters are abnormal, so as to automatically eliminate abnormality in real time. The central control system not only achieves precise control of the entire electric heating thermal desorption device, but also significantly saves the human resources for maintaining the device.

Furthermore, plural electric heating material processing devices of the present disclosure can be combined to form a series electric heating material processing devices and a parallel electric heating material processing devices. Since the series electric heating material processing device is formed by connecting many electric heating material processing devices in series, the materials go through the thermal desorption process in the series electric heating material processing device than that in the single electric heating material processing devices, and consequently have a higher temperature after leaving the series electric heating material processing device. In other words, the materials leaving the series electric heating material processing device have a better result of the thermal desorption treatment. The parallel electric heating material processing device uses the material distributor to evenly allocate the materials to every electric heating material processing device, and hence the thermal desorption process can be implemented more rapidly and efficiently comparing to those of the single electric heating material processing device, and further greatly increase the production capacity.

Although the embodiments of the present disclosure have been disclosed as above in the embodiments, they are not intended to limit the present disclosure. Any person having ordinary skill in the art can make various changes and modifications without departing from the spirit and the scope of the present disclosure. Therefore, the protection scope of the present disclosure should be determined according to the scope of the appended claims.

What is claimed is:

1. An electric heating material processing device, comprising:
a material transporting module configured to transport a plurality of materials, wherein the material transporting module has a material inlet and a material outlet;
a material feeding controller connected to the material inlet, wherein the material feeding controller is configured to control a feeding quantity of the materials and a feeding speed of the materials when the materials enter the material transporting module;
a material discharging controller connected to the material outlet, wherein the material discharging controller is configured to control a discharging quantity of the materials and a discharging speed of the materials when the materials leave the material transporting module;
a gas vent disposed on an end of the material transporting module, wherein the gas vent is configured to discharge a volatile gas; and
an electric heating thermal desorption device disposed on an outer surface of the material transporting module, wherein the electric heating thermal desorption device is configured to perform a thermal desorption process on the materials, and the electric heating thermal desorption device comprises:
an electric heating acceptor disposed on the outer surface of the material transporting module; and
a plurality of electric heaters contacting a portion of the electric heating acceptor.

2. The electric heating material processing device of claim 1, wherein the electric heating material processing device further comprises:
a feeding material thermometer disposed adjacent to the material feeding controller, wherein the feeding material thermometer is configured to measure a feeding temperature of the materials around the material feeding controller; and
a discharging material thermometer disposed adjacent to the material discharging controller, wherein the discharging material thermometer is configured to measure a discharging temperature of the materials around the material discharging controller.

3. The electric heating material processing device of claim 2, wherein the electric heating material processing device further comprises:
a central control system signally connected to the material transporting module, the material feeding controller, the material discharging controller, the electric heaters, the feeding material thermometer, and the discharging material thermometer, wherein the central control system is configured to control a plurality of material process parameters of the electric heating material processing device, and the material process parameters comprises a feeding speed parameter, a feeding temperature parameter, a transporting speed parameter, a heating energy parameter, a heating time parameter, a discharging speed parameter, and a discharging temperature parameter.

4. The electric heating material processing device of claim 1, wherein the material transporting module has a first opening and a second opening respectively disposed at two ends of the material transporting module opposite to each other, and the material transporting module comprises:
a material transporting device configured to move the materials from the first opening to the second opening;
two covers respectively covering the first opening and the second opening, wherein the two covers are configured to seal the first opening and the second opening; and
a motor engaged with the material transporting device wherein the motor is configured to drive the material transporting device.

5. The electric heating material processing device of claim 1, wherein the electric heaters are electric resistance heaters.

6. A series electric heating material processing device, comprising:
a material tank configured to store a plurality of materials; and
a plurality of electric heating material processing devices as recited in claim 1, wherein the material feeding controller of a first one of the electric heating material processing devices is connected to the material tank, and the material feeding controller of each of the remaining electric heating material processing devices is connected to the material discharging controller of another one of the remaining electric heating material processing devices.

7. A parallel electric heating material processing device, comprising:
a material tank configured to store a plurality of materials;
a material distributor connected to the material tank, and configured to extract the materials from the material tank;
a plurality of distributing pipes connected to the material distributor, wherein the distributing pipes are configured to distribute the materials; and
a plurality of the electric heating material processing devices as recited in claim 1, wherein the material feeding controllers of the electric heating material processing devices are correspondingly connected to the distributing pipes.

8. An electric heating material processing device, comprising:
a material transporting module configured to transport a plurality of materials, wherein the material transporting module has a material inlet and a material outlet;
a material feeding controller connected to the material inlet, wherein the material feeding controller is configured to control a feeding quantity of the materials and a feeding speed of the materials when the materials enter the material transporting module;
a material discharging controller connected to the material outlet, wherein the material discharging controller is configured to control a discharging quantity of the materials and a discharging speed of the materials when the materials leave the material transporting module;
a gas vent disposed on an end of the material transporting module, wherein the gas vent is configured to discharge a volatile gas; and
an electric heating thermal desorption device disposed on an outer surface of the material transporting module, wherein the electric heating thermal desorption device is configured to perform a thermal desorption process on the materials, and the electric heating thermal desorption device comprises:
an electric heating acceptor disposed on the outer surface of the material transporting module; and
a plurality of electric heaters adjacent to and do not contact the electric heating acceptor.

9. The electric heating material processing device of claim 8, wherein the electric heating material processing device further comprises:
a feeding material thermometer disposed adjacent to the material feeding controller, wherein the feeding material thermometer is configured to measure a feeding temperature of the materials around the material feeding controller; and
a discharging material thermometer disposed adjacent to the material discharging controller, wherein the discharging material thermometer is configured to measure a discharging temperature of the materials around the material discharging controller.

10. The electric heating material processing device of claim 9, wherein the electric heating material processing device further comprises:
a central control system signally connected to the material transporting module, the material feeding controller, the material discharging controller, the electric heaters, the feeding material thermometer, and the discharging material thermometer, wherein the central control system is configured to control a plurality of material process parameters of the electric heating material processing device, and the material process parameters comprises a feeding speed parameter, a feeding temperature parameter, a transporting speed parameter, a heating energy parameter, a heating time parameter, a discharging speed parameter, and a discharging temperature parameter.

11. The electric heating material processing device of claim 8, wherein the material transporting module has a first opening and a second opening respectively disposed at two ends of the material transporting module opposite to each other, and the material transporting module comprises:
a material transporting device configured to move the materials from the first opening to the second opening;
two covers respectively covering the first opening and the second opening, wherein the two covers are configured to seal the first opening and the second opening; and
a motor engaged with the material transporting device wherein the motor is configured to drive the material transporting device.

12. The electric heating material processing device of claim 8, wherein the electric heaters are electromagnetic induction heaters.

13. A series electric heating material processing device, comprising:
a material tank configured to store a plurality of materials; and
a plurality of electric heating material processing devices as recited in claim 8, wherein the material feeding controller of a first one of the electric heating material processing devices is connected to the material tank, and the material feeding controller of each of the remaining electric heating material processing devices is connected to the material discharging controller of another one of the remaining electric heating material processing devices.

14. The series electric heating material processing device of claim 13, wherein each of the electric heating material processing devices further comprises:
a feeding material thermometer disposed adjacent to the material feeding controller, wherein the feeding material thermometer is configured to measure a feeding temperature of the materials around the material feeding controller; and
a discharging material thermometer disposed adjacent to the material discharging controller, wherein the discharging material thermometer is configured to measure a discharging temperature of the materials around the material discharging controller,
wherein the series electric heating material processing device further comprises:
a plurality of central control systems signally connected to the material transporting modules, the material feeding controllers, the material discharging controllers, and the electric heating thermal desorption devices correspondingly, wherein the central control systems are configured to control a plurality of material process parameters of the electric heating material processing devices.

15. A parallel electric heating material processing device, comprising:
a material tank configured to store a plurality of materials;
a material distributor connected to the material tank, and configured to extract the materials from the material tank;
a plurality of distributing pipes connected to the material distributor, wherein the distributing pipes are configured to distribute the materials; and
a plurality of the electric heating material processing devices as recited in claim 8, wherein the material feeding controllers of the electric heating material processing devices are correspondingly connected to the distributing pipes.
